(19) United States
(12) Patent Application Publication
(10) Pub. No.: US 2023/0237636 A1
(43) Pub. Date: Jul. 27, 2023

(54) VISION INSPECTION SYSTEM FOR DEFECT DETECTION

(71) Applicants: TE Connectivity Services GmbH, Schaffhausen (CH); Tyco Electronics (Shanghai) Co., Ltd., Shanghai (CN); Tyco Electronics Mexico, S. de R.L. de C.V., Tlalnepantla (MX)

(72) Inventors: Sonny O. Osunkwo, Harrisburg, PA (US); Lei Zhou, Shanghai (CN); Roberto Francisco-Yi Lu, Bellevue, WA (US); Dandan Zhang, Shanghai (CN); Jiankun Zhou, Middletown, PA (US); Angel Alberto Slistan, Hermosillo Sonora (MX); Tianyi Gao, Middletown, PA (US)

(21) Appl. No.: 17/679,172

(22) Filed: Feb. 24, 2022

(30) Foreign Application Priority Data
Jan. 27, 2022 (CN) 202210099543.8

(51) Int. Cl. G06T 7/00; G06V 10/764; G06V 10/774; G06V 10/82; G06V 10/94

(52) U.S. Cl. CPC G06T 7/0004; G06V 10/764; G06V 10/774; G06V 10/82; G06V 10/945; G06T 2207/20081; G06T 2207/20092; G06T 2207/20084

(57) ABSTRACT

A vision inspection system includes a vision inspection controller receiving images form an imaging device. The vision inspection controller includes a binary classification tool and a multi-classification tool. The vision inspection controller processes each of the images through the binary classification tool to detect for the defects to determine primary inspection results including a PASS result if no defects are detected and a FAIL result if defects are detected. The vision inspection controller processes each of the images associated with the FAIL result through the multi-classification tool to determine secondary inspection results including identification of a type of defect. The vision inspection system may include a display configured to display the primary and secondary inspection results to an operator.

### CROSS REFERENCE TO RELATED APPLICATIONS

This application claims benefit to Chinese Application No. 202210099543.8, filed 27 Jan. 2022, the subject matter of which is herein incorporated by reference in its entirety.

### BACKGROUND OF THE INVENTION

The subject matter herein relates generally to product assembly machines.

Inspection systems are used for inspecting parts or products during a manufacturing process to detect defective parts or products. Conventional inspection systems use personnel to manually inspect parts. Such manual inspection systems are labor intensive and high cost. The manual inspection systems have low detection accuracy leading to poor product consistency. Additionally, manual inspection systems suffer from human error due to fatigue, such as missed defects, wrong counts, misplacing of parts, and the like. Some known inspection systems use machine vision for inspecting parts or products. The machine vision inspection system use cameras to image the parts or products. However, vision inspection may be time consuming. Hardware and software for operating the vision inspection machines is expensive.

A need remains for a vision inspection system for a product assembly machine that may be operated in a cost effective and reliable manner.

### BRIEF DESCRIPTION OF THE INVENTION

In one embodiment, a vision inspection system is provided and includes an imaging device to image products for at least one of manufacture or assembly defects. The imaging device provided at an inspection area of an inspection station. The vision inspection system includes a vision inspection controller receiving images form the imaging device. The vision inspection controller includes a binary classification tool and a multi-classification tool. The vision inspection controller processes each of the images through the binary classification tool to detect for the defects to determine primary inspection results includes a PASS result if no defects are detected and a FAIL result if defects are detected. The vision inspection controller processes each of the images associated with the FAIL result through the multi-classification tool to determine secondary inspection results includes identification of a type of defect. The vision inspection system may include a display coupled to the vision inspection controller. The display is configured to display the primary inspection results to an operator. The display is configured to display the secondary inspection results to the operator.

In another embodiment, a vision inspection system is provided and includes an imaging device to image products for at least one of manufacture or assembly defects. The imaging device is provided at an inspection area of an inspection station. The vision inspection system includes a vision inspection controller receiving images form the imaging device. The vision inspection controller includes a multi-classification tool. The vision inspection controller processes the images through the multi-classification tool to determine inspection results includes identification of a type of defect. The vision inspection system may include a user interface communicatively coupled to the vision inspection controller having a user input and a display configured to display the secondary inspection results to the operator. The vision inspection controller includes a multi-classification tool training module having an image directory with multiple folders configured to receive the images from the imaging device. The multi-classification tool training module having an input function configured to receive label inputs from the user input to label the folders in the image directory with defect class labels. The vision inspection controller placing the images in the appropriate folders in the image directory based on the defect class labels.

In a further embodiment, a method of inspecting products using a vision inspection system is provided and has an imaging device. The method images the products at an imaging area of an inspection station. The method processes the images using a binary classification tool to detect for defects to determine primary inspection results includes a PASS result if no defects are detected and a FAIL result if defects are detected and processes each of the images associated with the FAIL result through a multi-classification tool to determine secondary inspection results includes identification of a type of defect. The method displays the primary inspection results to an operator at a display and displays the secondary inspection results to the operator at the display includes identification of the type of defects.

### BRIEF DESCRIPTION OF THE DRAWINGS

FIG. 1 is a schematic illustration of a product assembly machine for assembling products from a plurality of parts, such as first parts and second parts in accordance with an exemplary embodiment.

FIG. 2 is a flow chart showing an exemplary method of inspecting products for defects in accordance with an exemplary embodiment.

FIG. 3 is a display of inspection results in accordance with an exemplary embodiment.

FIG. 4 is a flow chart showing a method of training a multi-classification tool of a vision inspection system in accordance with an exemplary embodiment.

### DETAILED DESCRIPTION OF THE INVENTION

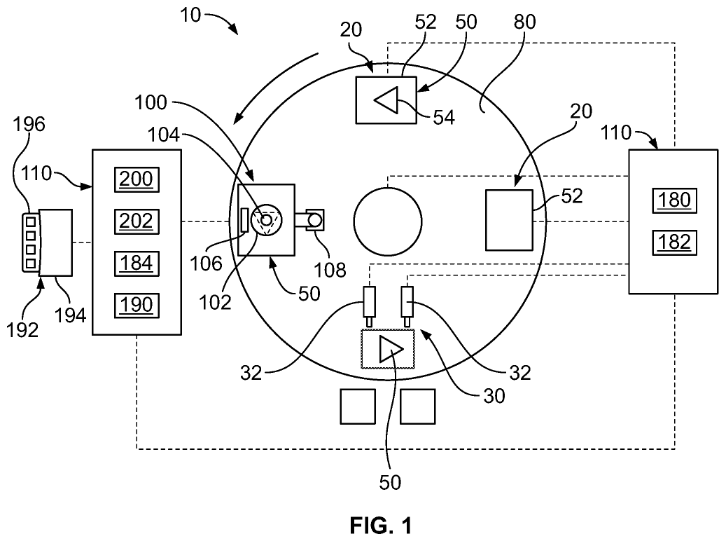

FIG. 1 is a schematic illustration of a product assembly machine 10 for assembling products 50 from a plurality of parts, such as first parts 52 and second parts 54. The parts 52, 54 are assembled together to form the assembled products 50. For example, the first parts 52 may be received in the second parts 54 during assembly. In an exemplary embodiment, the product assembly machine 10 includes one or more assembling station 20 used to assemble the various parts into the assembled products 50. In various embodiments, multiple assembling stations 20 are provided to assemble multiple parts in stages. In various embodiments, the assembled products 50 are electrical connectors. For example, the parts may include contacts, housings, circuit boards, or other types of parts to form the assembled products 50. In various embodiments, the parts may include springs, such as ring shaped springs, C-clips, and the like that are received in housings. The machine 10 may be used for mounting contacts, connectors or other components on a printed circuit board. The machine 10 may be used for manufacturing parts used in other industries in alternative embodiments.

The product assembly machine 10 includes a vision inspection system 100 used to inspect the various assembled products 50. The assembled products 50 are transported between the assembling station 20 and the vision inspection system 100. The vision inspection system 100 is used for quality inspection of the assembled products 50, such as to identify defects in one or more of the parts 54 or in the products 50. The defects may be manufacture defects (for example, defects in manufacturing one or more of the parts 54) or the defects may be assembly defects (for example, defects from assembly of the parts to make the product 50). Optionally, the product assembly machine 10 may remove defective products 50 for scrap or further inspection based on input from the vision inspection system 100. The acceptable assembled products 50 that have passed inspection by the vision inspection system 100 are transported away from the product assembly machine 10, such as to a bin or another machine for further assembly or processing.

The product assembly machine 10 includes a platform 80 that supports the parts 52, 54 and the assembled products 50 between the various stations. For example, the platform 80 is used to move the first part 52 and/or the second part 54 to the assembling station 20 where the parts 52, 54 are assembled. The platform 80 may include fixturing elements used to support and position the part 52 and/or the part 54 relative to the platform 80. The platform 80 is used to move the assembled products 50 to the vision inspection system 100. The platform 80 is used to transfer the assembled products 50 from the vision inspection system 100 to a product removal station 30 where the assembled products 50 are removed. In an exemplary embodiment, the product removal station 30 may be used to separate acceptable assembled products 50 from defective assembled products 50, such as by separating the assembled products 50 into different bins.

The vision inspection system 100 includes one or more imaging devices 102 at an inspection station 108. The imaging devices 102 image the assembled products 50 on the platform 80 within a field of view of the imaging device(s) 102. The vision inspection system 100 includes a vision inspection controller 110 that receives the images from the imaging device 102 and processes the images to determine inspection results. For example, the vision inspection controller 110 determines if the parts 54 and/or the assembled product 50 passes or fails inspection. The vision inspection controller 110 may reject assembled products 50 that are defective. In an exemplary embodiment, the vision inspection controller 110 includes a shape recognition tool configured to recognize the parts 54 and/or the assembled products 50 in the field of view, such as boundaries of the parts 52, 54 and relative positions of the parts 52, 54. In an exemplary embodiment, the vision inspection controller 110 includes an artificial intelligence (AI) learning module used to update an image analysis model based on the images received from the imaging device 102. For example, the image analysis model may be updated based on data from the AI learning module. The image analysis model may be customized based on learning or training data from the AI learning module. The vision inspection controller 110 may be updated and trained in real time during operation of the vision inspection system 100.

After the assembled products 50 are inspected, the assembled products 50 are transferred to the product removal station 30 where the assembled products 50 are removed from the platform 80. In an exemplary embodiment, the product removal station 30 may be used to separate acceptable assembled products 50 from defective assembled products 50 based on inspection results determined by the vision inspection controller 110. The product removal station 30 may include ejectors, such as vacuum ejectors for picking up and removing the assembled products 50 from the platform 80. The product removal station 30 may include ejectors, such as pushers, for removing the assembled products 50 from the platform 80. The product removal station 30 may include a multi-axis robot manipulator configured to grip and pick the products 50 off of the platform 80.

In an alternative embodiment, the vision inspection system 100 is used independent of the product assembly machine 10. For example, the vision inspection system 100 may be a stand alone system where the products 50 are presented to the stand alone inspection station 108 and imaged at the stand alone inspection station 108. In other words, the products 50 are removed from the platform 80 and the product assembly machine 10 and then transported to the separate inspection station 108.

In an exemplary embodiment, the vision inspection system 100 includes the imaging device 102, a lens 104, and a lighting device 106 arranged adjacent the imaging area above the platform 80 to image the assembled product 50. The lens 104 is used to focus the images. The lighting device 106 controls lighting of the assembled product 50 at the imaging area. The imaging device 102 may be a camera, such as a high-speed camera. Other types of imaging devices may be used in alternative embodiments, such as non-visible light imaging devices, such as infrared cameras, thermal imaging devises, X-ray devices, and the like. Optionally, the vision inspection system 100 may include a second imaging device 102, second lens 104 and second lighting device 106, such as below the platform 80 to image the bottom of the assembled product 50. The second imaging device 102 may be at other locations to image other portions of the assembled product 50, such as a side of the assembled product 50. In other various embodiments, a second vision inspection system 100 may be provided remote from the first vision inspection system 100, such as to image the assembled product 50 at a different stage of assembly. For example, such vision inspection system 100 may be located between two different assembling stations 20.

In an exemplary embodiment, the imaging device 102 is mounted to a position manipulator for moving the imaging device 102 relative to the platform 80. The position manipulator may be an arm or a bracket that supports the imaging device 102. In various embodiments, the position manipulator may be positionable in multiple directions, such as in two-dimensional or three-dimensional space. The position manipulator may be automatically adjusted, such as by a controller that controls positioning of the position manipulators. The position manipulator may be adjusted by another control module, such as an AI control module. In other various embodiments, the position manipulator may be manually adjusted. The position of the imaging device 102 may be adjusted based on the types of assembled products 50 being imaged. For example, when a different type of assembled product 50 is being imaged, the imaging device 102 may be moved based on the type of part being imaged.

The imaging device 102 communicates with the vision inspection controller 110 through machine vision software to process the data, analyze results, record findings, and make decisions based on the information. The vision inspection controller 110 provides consistent and efficient inspection automation. The vision inspection controller 110 determines the quality of manufacture of the assembled products 50, such as determining if the assembled products 50 are acceptable or are defective. The vision inspection controller 110 identifies defects in the parts 52, 54 and/or the assembled product 50, when present. For example, the vision inspection controller 110 may determine if either of the parts 52, 54 are damaged during assembly. The vision inspection controller 110 may determine if the parts 52, 54 are correctly assembled, such as that the parts 52, 54 are in proper orientations relative to each other. The vision inspection controller 110 may determine the orientations of either or both of the parts 52, 54 and/or the assembled products 50. The vision inspection controller 110 is operably coupled to the product removal station 30 for controlling operation of the product removal station 30. The vision inspection controller 110 controls operation of the product removal station 30 based on the identified orientation of the assembled products 50.

The vision inspection controller 110 receives the images from the imaging device 102 and processes the images to determine inspection results. In an exemplary embodiment, the vision inspection controller 110 includes one or more processors 180 for processing the images and one or more memories 182 for storing data, storing the images, and storing executable instructions for controlling the processors 180. The vision inspection controller 110 determines if the assembled product 50 passes or fails inspection. The vision inspection controller 110 controls the product removal station 30 to remove the assembled products 50, such as the acceptable parts and/or the defective parts, into different collection bins (for example, a pass bin and a fail bin). In an exemplary embodiment, the vision inspection controller 110 includes a shape recognition tool configured to recognize the assembled products 50 in the field of view. The shape recognition tool is able to recognize and analyze the image of the assembled product 50. The shape recognition tool may be used to identify edges, surfaces, boundaries and the like of the parts 52, 54 and the assembled product 50. The shape recognition tool may be used to identify relative positions of the parts 52, 54 in the assembled product 50.

Once the images are received, the images are processed based on an image analysis model. The images are compared to the image analysis model to determine if the assembled product 50 has any defects. The image analysis model may be a three-dimensional model defining a baseline structure of the assembled product 50 being imaged. In other various embodiments, the image analysis model may be a series of two-dimensional models, such as for each imaging device 102. The image analysis model may be based on images of known or quality passed assembled product 50, such as during a learning or training process. The image analysis model may be based on the design specifications of the assembled product 50. For example, the image analysis model may include design parameters for edges, surfaces, and features of the assembled product 50. The image analysis model may include tolerance factors for the parameters, allowing offsets within the tolerance factors. During processing, the images may be individually processed or may be combined into a digital model of the assembled product 50, which is then compared to the image analysis model. The images may be processed to detect damage, improper orientation, partial assembly, full assembly, over-assembly, dirt, debris, dents, scratches, or other types of defects. The images may be processed by performing pattern recognition of the images based on the image analysis model. For example, in an exemplary embodiment, the vision inspection controller 110 includes a pattern recognition tool 184 configured to compare patterns or features in the images to patterns or features in the image analysis model. The images may be processed by performing feature extraction of boundaries and surfaces detected in the images and comparing the boundaries and surfaces to the image analysis model. The vision inspection controller 110 may identify lines, edges, bridges, grooves, or other boundaries or surfaces within the image.

In an exemplary embodiment, the vision inspection controller 110 may perform pre-processing of the image data. For example, the vision inspection controller 110 may perform contrast enhancement and/or noise reduction of the images during processing. The vision inspection controller 110 may perform image segmentation during processing. For example, the vision inspection controller may crop the image to an area of interest or mask areas of the image outside of the area of interest, thus reducing the data that is processed by the vision inspection controller 110. The vision inspection controller 110 may identify areas of interest within the image for enhanced processing.

In an exemplary embodiment, the vision inspection controller 110 includes an artificial intelligence (AI) learning module 190. The AI learning module 190 uses artificial intelligence to train the vision inspection controller 110 and improve inspection accuracy of the vision inspection controller 110. The AI learning module 190 update image analysis based on the images received from the imaging device 102. The vision inspection controller 110 is updated and trained in real time during operation of the vision inspection system 100. The AI learning module 190 of the vision inspection controller 110 may be operable in a learning mode to train the vision inspection controller 110 and develop the image analysis model. The image analysis model changes over time based on input from the AI learning module 190 (for example, based on images of the assembled products 50 taken by the imaging device 102). The image analysis model may be updated based on data from the AI learning module. For example, an image library used by the image analysis model may be updated and used for future image analysis. The imaging analysis module may use a shape recognition tool or a pattern recognition tool for analyzing shapes, boundaries or other features of the assembled products 50 in the image and such shape or pattern recognition tools may be used by the AI learning module 190 to update and train the AI learning module, such as by updating an image library used by the AI learning module 190. In various alternative embodiments, the AI learning module 190 may be a separate module from the vision inspection controller 110 and independently operable from the vision inspection controller 110. For example, the AI learning module 190 may be separately coupled to the imaging devices 102 or other components of the machine.

In an exemplary embodiment, the vision inspection controller 110 includes a user interface 192. The user interface 192 includes a display 194, such as a monitor. The user interface 192 includes one or more inputs 196, such as a keyboard, a mouse, buttons, and the like. An operator is able to interact with the vision inspection controller 110 with the user interface 192.

In an exemplary embodiment, the vision inspection system 100 includes a binary classification tool 200 and a multi-classification tool 202. The binary classification tool 200 is used for processing each of the images and is configured to output two outputs. The multi-classification tool 202 is used to process a subset of the images (for example, less than all of the images) and is configured to output multiple outputs, such as greater than two outputs. In an exemplary embodiment, the vision inspection controller 110 processes each of the images through the binary classification tool 200 to detect for defects to determine primary inspection results. The primary inspection results include two outputs that generally relate to the presence of defects or the absence of defects. For example, the primary inspection results may be a PASS (or GOOD) result if no defects are detected and a FAIL (or NO GOOD/NG) result if defects are detected. The outputs may be digitally binary outputs, such as 1 corresponding to a passing result or a 0 corresponding to a failing result. Other types of binary results may be provided in alternative embodiments.

In an exemplary embodiment, the vision inspection controller 110 processes each of the images associated with the FAIL result through the multi-classification tool 202 to determine secondary inspection results. As such, only the defective images are processed through the multi-classification tool 202. The multi-classification tool 202 does not process the good or passing images. The secondary inspection results include identification of the type of defect detected. The operator may identify the various types of defects that the vision inspection system 100 is used to identify and the multi-classification tool 202 determines the particular defect type for each image from the identified types. The types of defects depend on the type of assembled product 50 being inspected (for example, contact or connector or circuit board or other type of product). The defect types are user defined defect classes. For example, the user may select from different types of defect classes depending on the particular product being inspected. The vision inspection controller 110 may automatically update the secondary inspection results when the user selected defect classes are changed. The vision inspection controller 110 may include an image directory having multiple folders configured to store the images based on the type of defect. When the defect in the image is identified, the image is stored in the particular folder associated with the particular type of defect. The images may be further analyzed or characterized after being filed and stored.

In an exemplary embodiment, the vision inspection controller 110 includes a first processor associated with the binary classification tool 200 for processing the images and a second processor associated with the multi-classification tool 202, different from the first processor, for processing only the images associated with the FAIL results. As such, the binary classification tool 200 and the multi-classification tool 202 may be operated independently. The processing by the multi-classification tool 202 does not slow the processing of the binary classification tool 200, which increases the throughput of the vision inspection system 100.

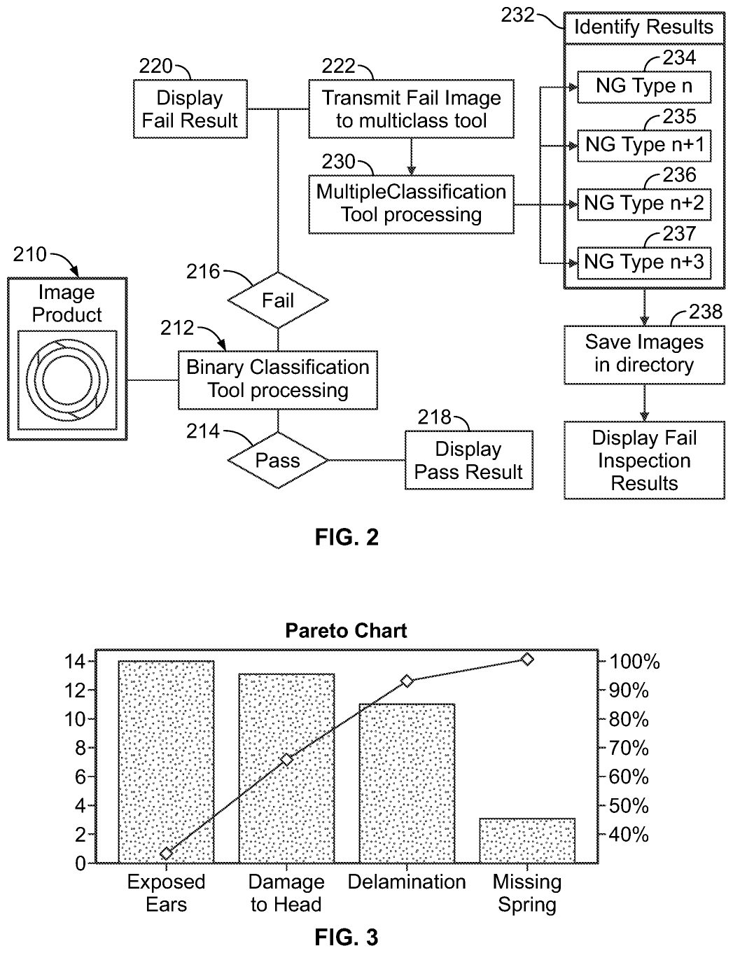

FIG. 2 is a flow chart showing an exemplary method of inspecting products for defects. The method uses a vision inspection system to image the products to identify defects. The method is used to determine if the products are defective and is used to determine the types of defects. The method may be used to identify various types of defects for various types of products. In various embodiments, the method is used to inspect electrical components, such as contacts, connectors, printed circuit boards, or other types of electrical components. The method may be used to identify damage to one or more parts of the assembled product, to identify defects in manufacturing one or more of the parts of the assembled product, to identify improper assembly of the parts, and the like.

The method includes the step of imaging 210 the product. The product may be imaged by one or more imaging devices, such as cameras. The product may be imaged at an imaging station. The quality of the image may be affected by proper lighting of the product in the inspection area as well as control of the image clarity, such as by controlling the resolution, the lens, the zoom, and the like. The product may be imaged from different angles, such as using multiple imaging devices to image different portions of the product.

The method includes processing 212 the images using a binary classification tool. The binary classification tool includes one or more processors and one or more memories for analyzing the images for defect identification. The binary classification tool produces two inspection results, such as a PASS result 214 and a FAIL result 216. If no defects are detected, the binary classification tool outputs the PASS result and the product inspection system displays 218 the positive result. For example, the PASS result may be displayed on a monitor to the operator, either by a textual indicator (for example, PASS), a color coded indicator (for example, green), a symbol (for example, check mark), and the like.

If defects are detected, the binary classification tool outputs the FAIL result and the product inspection system displays 220 the negative result. For example, the FAIL result may be displayed on the monitor to the operator, either by a textual indicator (for example, FAIL), a color coded indicator (for example, red), a symbol (for example, an X), and the like. If defects are detected, the method includes transmitting 222 the image to a multi-classification tool. In an exemplary embodiment, only the FAIL images are transmitted to the multi-classification tool. As such, the multi-classification tool only processes the FAIL images and does not process the PASS images, thus reducing the total number of images that the multi-classification tool needs to analyze reducing the processing time for the vision inspection system. The method includes processing 230 the images using the multi-classification tool. The multi-classification tool includes one or more processors and one or more memories for analyzing the images to identify the type of defects. The multi-classification tool identifies 232 multiple inspection results 234, 235, 236, 237, such as a PASS result 214 and a FAIL result 216. In an exemplary embodiment, the types of defects may be user defined. For example, the operator may select the types of defects that the vision inspection system is configured to inspect. The operator may select any number of defects to inspect. The multi-classification tool may identify the inspection results by identifying inspection result folders in a folder directory, such as a database. Optionally, the operator may label the folders with the type of defect or other identifying indicia within the database. The method further includes saving 238 the images in the results folders in the directory. Each result folder includes each of the images with a particular type of defect. Optionally, an image may be saved in multiple folders in the directory if multiple types of defects are detected.

In an exemplary embodiment, the method includes displaying 240 inspection results at the display. The inspection results may be displayed as a chart for reference by the operator. The chart may be a visual indication of the types of defects. For example, the chart may be a pareto chart, a pie chart, a bar graph, a spreadsheet, and the like.

FIG. 3 is a display of inspection results in accordance with an exemplary embodiment. FIG. 3 shows the secondary inspection results of the multi-classification tool. In the illustrated embodiment, the chart is a pareto chart showing four defect results, including “Exposed Ears”, “Damage to Head”, “Delamination”, and “Missing Spring”. The categories may be manually labeled by the operator when labeling the folders in the directory. Alternatively, the categories may be automatically labeled by the system based on the types of defects identified. The chart shows frequency of the various types of defects by bar graphs. The chart shows the cumulative total of the defects by a line graph. Other types of charts may be used in alternative embodiments.

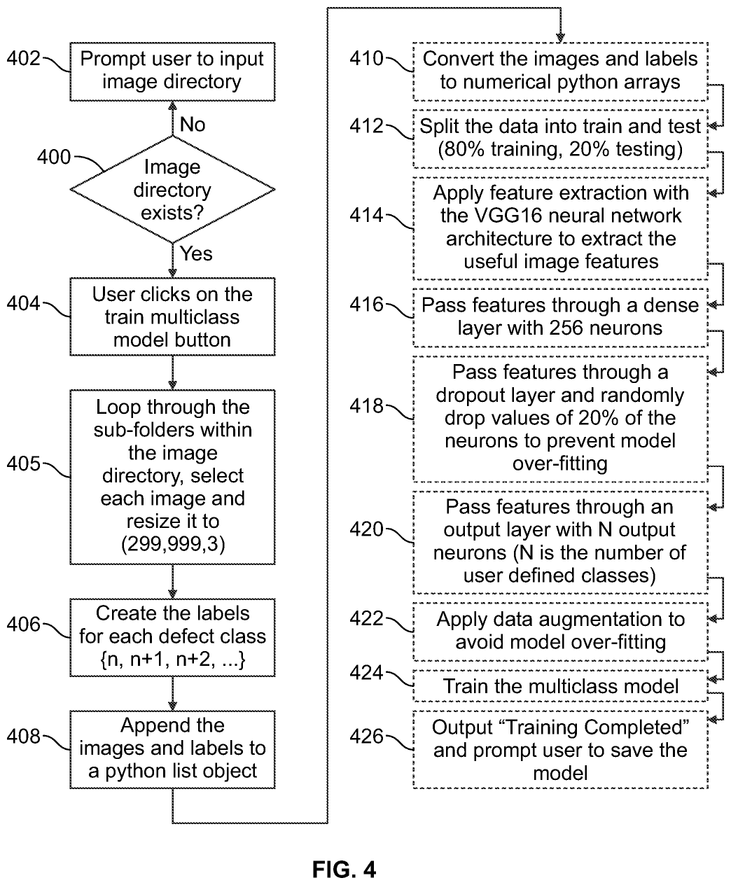

FIG. 4 is a flow chart showing a method of training a multi-classification tool of a vision inspection system. The method may be performed offline in various embodiments, such as prior to an inspection run of products. The method may include using actual images taken by the machine or a set of training images that are uploaded to the machine during system set up or calibration.

The method includes determining 400 if an image directory exists. If no image directory exists, the system prompts 402 the user to input an image directory. When the image directory exists, the user clicks 404 on a train multi-class model button. The system analyzes 405 the sub-folders in the image directory and selects each image to resize the images to a particular size, such as to a size of 299, 299, 3. At step 406, labels are created for each defect class. The labels may be created manually by the user or automatically by the system based on the types of defects detected in the images.

At step 408, the method includes appending the images and labels to a python list object. The images and labels are then converted 410 to numerical python arrays. The data is then split 412 into a train dataset and a test dataset. For example, the data may be split 80% for training and 20% for testing; however, other splits are possible in alternative embodiments.

At step 414, a feature extraction model is applied, such as with a VGG16 neural network architecture to extract useful image features. The features are passed 416 through a dense layer of the neural network architecture. In an exemplary embodiment, the features are passed 418 through a propout layer to randomly drop out values (for example, 20% of the neurons) to prevent model overfitting. The features are passed 420 through an output layer with N output neurons (where N is the number of user defined classes). In an exemplary embodiment, the method includes applying 422 data augmentation to avoid model over-fitting. The multi-classification model is then trained 424. The system may output 426 a “Training Completed” message and prompt the user to save the model. The model may be converted to a readable format used by the multi-classification tool of the vision inspection system and is useable for classifying images taken by the machine during production.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the invention without departing from its scope. Dimensions, types of materials, orientations of the various components, and the number and positions of the various components described herein are intended to define parameters of certain embodiments, and are by no means limiting and are merely exemplary embodiments. Many other embodiments and modifications within the spirit and scope of the claims will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. § 112(f), unless and until such claim limitations expressly use the phrase “means for” followed by a statement of function void of further structure.

What is claimed is:

1. A vision inspection system comprising:
an imaging device to image products for at least one of manufacture or assembly defects, the imaging device provided at an inspection area of an inspection station; and
a vision inspection controller receiving images form the imaging device, the vision inspection controller including a binary classification tool and a multi-classification tool, the vision inspection controller processing each of the images through the binary classification tool to detect for the defects to determine primary inspection results including a PASS result if no defects are detected and a FAIL result if defects are detected, the vision inspection controller processing each of the images associated with the FAIL result through the multi-classification tool to determine secondary inspection results including identification of a type of defect.

2. The vision inspection system of claim 1, wherein the binary classification tool has only two results, and wherein the multi-classification tool has greater than two results.

3. The vision inspection system of claim 1, wherein the vision inspection controller includes a first processor associated with the binary classification tool for processing the images, and wherein the vision inspection controller includes a second processor associated with the multi-classification tool for processing only the images associated with the FAIL results.

4. The vision inspection system of claim 1, wherein the secondary inspection results are user defined defect classes.

5. The vision inspection system of claim 1, wherein the vision inspection controller is configured to automatically update the secondary inspection results if the number of defect classes is changed.

6. The vision inspection system of claim 1, further comprising a display coupled to the vision inspection controller, the display configured to display the primary inspection results to an operator, the display configured to display the secondary inspection results to the operator.

7. The vision inspection system of claim 6, wherein the display of the secondary inspection results incudes a chart.

8. The vision inspection system of claim 6, wherein the display of the secondary inspection results incudes a chart showing frequency of the types of defects.

9. The vision inspection system of claim 1, wherein the vision inspection controller includes an image directory having multiple folders configured to store the images based on the type of defect.

10. The vision inspection system of claim 1, wherein the vision inspection controller includes a multi-classification tool training module having an image directory with multiple folders configured to receive the images from the imaging device, the multi-classification tool training module having an input function configured to receive label inputs from a user input to label the folders in the image directory with defect class labels, the vision inspection controller placing the images in the appropriate folders in the image directory based on the defect class labels.

11. A vision inspection system comprising:
an imaging device to image products for at least one of manufacture or assembly defects, the imaging device provided at an inspection area of an inspection station; and
a vision inspection controller receiving images form the imaging device, the vision inspection controller including a multi-classification tool, the vision inspection controller processing the images through the multi-classification tool to determine inspection results including identification of a type of defect;
wherein the vision inspection controller including a multi-classification tool training module having an image directory with multiple folders configured to receive the images from the imaging device, the multi-classification tool training module having an input function configured to receive label inputs from the user input to label the folders in the image directory with defect class labels, the vision inspection controller placing the images in the appropriate folders in the image directory based on the defect class labels.

12. The vision inspection system of claim 11, wherein the inspection results are user defined defect classes.

13. The vision inspection system of claim 11, further comprising a user interface communicatively coupled to the vision inspection controller, the user interface including a user input and a display, the display configured to display the secondary inspection results to the operator.

14. The vision inspection system of claim 13, wherein the display of the inspection results incudes a chart showing frequency of the types of defects.

15. The vision inspection system of claim 11, wherein the multi-classification tool training module includes a neural network architecture.

16. The vision inspection system of claim 11, wherein the multi-classification tool training module includes a neural network architecture having an output layer with N output neurons where N is the number of user defined defect classes.

17. The vision inspection system of claim 11, wherein the vision inspection controller includes a binary classification tool, the vision inspection controller processing each of the images through the binary classification tool to detect for the defects to determine primary inspection results including a PASS result if no defects are detected and a FAIL result if defects are detected, the vision inspection controller only processing the images associated with the FAIL result through the multi-classification tool to determine the inspection results of the multi-classification tool.

18. A method of inspecting products using a vision inspection system having an imaging device, the method comprising:
imaging the products at an imaging area of an inspection station;
processing the images using a binary classification tool to detect for defects to determine primary inspection results including a PASS result if no defects are detected and a FAIL result if defects are detected;
processing each of the images associated with the FAIL result through a multi-classification tool to determine secondary inspection results including identification of a type of defect; and
displaying the primary inspection results to an operator at a display; and
displaying the secondary inspection results to the operator at the display including identification of the type of defects.

19. The method of claim 18, wherein said processing the images using the binary classification tool comprises processing the images using a first processor and said processing each of the images associated with the FAIL result through the multi-classification tool comprises processing the images using a second processor.

20. The method of claim 18, wherein said processing each of the images associated with the FAIL result through the multi-classification tool comprises processing the images using user defined defect classes.

21. The method of claim 18, wherein said displaying the secondary inspection results includes displaying a chart showing frequency of the types of defects.

22. The method of claim 18, further comprising storing the images in different folders in an image directory based on the type of defect.
